(19) United States
(12) Patent Application Publication
(10) Pub. No.: US 2008/0266923 A1
(43) Pub. Date: Oct. 30, 2008

(54) Power inverter

(76) Inventors: Shih-Wei Chang, Jhudong Township (TW); Yu-Chen Liu, Vancouver (CA)

Correspondence Address: TROXELL LAW OFFICE PLLC, SUITE 1404, 5205 LEESBURG PIKE, FALLS CHURCH, VA, 22041, US

(21) Appl. No.: 11/790,476

(22) Filed: Apr. 25, 2007

(51) Int. Cl. H02M 7/537

(52) U.S. Cl. 363/131

(57) ABSTRACT

A power inverter is disclosed. The power inverter includes an electronic switching circuit designed to be electrically connected to a DC power supply. A power inverter circuit is electrically connected to the electronic switching circuit for converting a DC supply voltage to an AC voltage and has output terminals to output the resulting AC voltage. The power inverter further includes a microprocessor having an oscillating circuit provided therein for counting time. The microprocessor is constructed to be able to send a control signal to the electronic switching circuit at a desired time to order the electronic switching circuit to break the power inverter circuit.

### FIELD OF THE INVENTION

The present invention relates to a power inverter and, more particularly, to a power inverter which converts DC power into AC power and which can turn off itself automatically at a desired time.

### BACKGROUND OF THE INVENTION

Electrical apparatuses are useful in our daily life. Most of them must be supplied with AC power from wall outlets, which are usually unavailable in places far from buildings. For this reason, power inverters that may convert DC low-voltage power into AC power necessary for the apparatuses are developed.

However, these power inverters still insult in a problem, especially when a car battery is used as the DC power, that the battery may run down unexpectedly if the user forget to switch off the apparatus in time.

Further, in respect of solar battery, if it cannot be continued charged, after long time using, the battery may run down unexpectedly.

Therefore, there is a need for an improved power inverter to solve the problem of the prior art.

### SUMMARY OF THE INVENTION

It is an object of the present invention to provide a power inverter which may automatically turn off itself at a desired time.

Another object of the present invention is to provide a power inverter which may automatically turn off itself in a desired period of time if being non-loaded.

To achieve the aforementioned objects, the present invention provides a power inverter including an electronic switching circuit designed to be electrically connected to a DC power supply. A power inverter circuitry is electrically connected to the electronic switching circuit for converting a DC supply voltage to an AC voltage, and has output terminals to output the AC voltage. The power inverter further includes a microprocessor having an oscillating circuit provided therein for counting time. The microprocessor is constructed to be able to send a control signal to the electronic switching circuit at a desired time to order the electronic switching circuit to break the power inverter circuitry.

Preferably, the electronic switching circuit includes a first n-p-n bipolar transistor having an emitter electrically connected to the power inverter circuitry, and a second n-p-n bipolar transistor having an emitter electrically connected to a base of the first n-p-n bipolar transistor and a collector electrically connected to the supply voltage provided by the DC power supply.

Additionally, a first resistor is electrically connected between the supply voltage and a node, a second resistor is electrically connected between a base of the second n-p-n bipolar transistor and the node, and a third resistor is electrically connected between a collector of the first n-p-n bipolar transistor and the supply voltage.

The electronic switching circuit is further provided with a third n-p-n bipolar transistor has an emitter electrically connected to ground, a base electrically connected to the microprocessor and a collector electrically connected to the node.

Other objects, advantages and novel features of this invention will become more apparent from the following detailed description when taken in conjunction with the accompanying drawings.

### BRIEF DESCRIPTION OF THE DRAWINGS

FIG. 1 is a block diagram of a first embodiment of a power inverter in accordance with the present invention;

FIG. 2 is a circuit diagram of the power inverter shown in FIG. 1;

FIG. 3 is a circuit diagram of an electronic switching circuit included in the power inverter;

FIG. 4 is a circuit diagram showing the flow of current in the electronic switching circuit during the time when the switching circuit is being turned on;

FIG. 5 is a circuit diagram showing the flow of current in the electronic switching circuit during the time when the switching circuit is being turned off; and

FIG. 6 is a block diagram of a second embodiment of the inventive power inverter.

### DETAILED DESCRIPTION OF THE PREFERRED EMBODIMENT

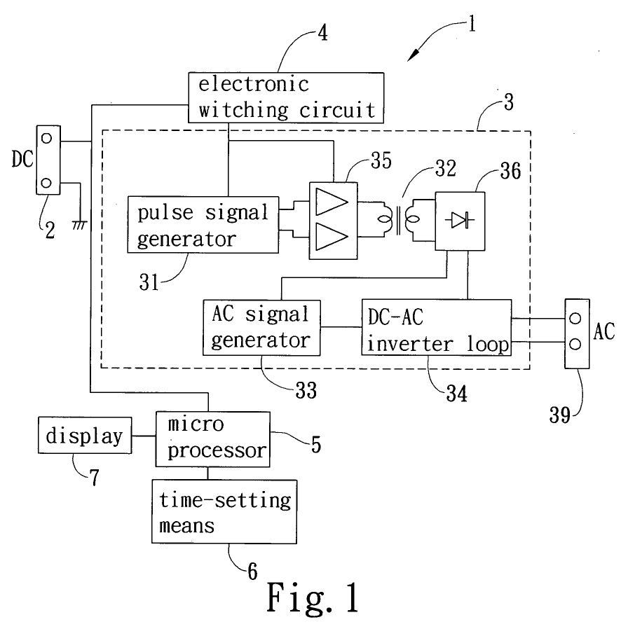

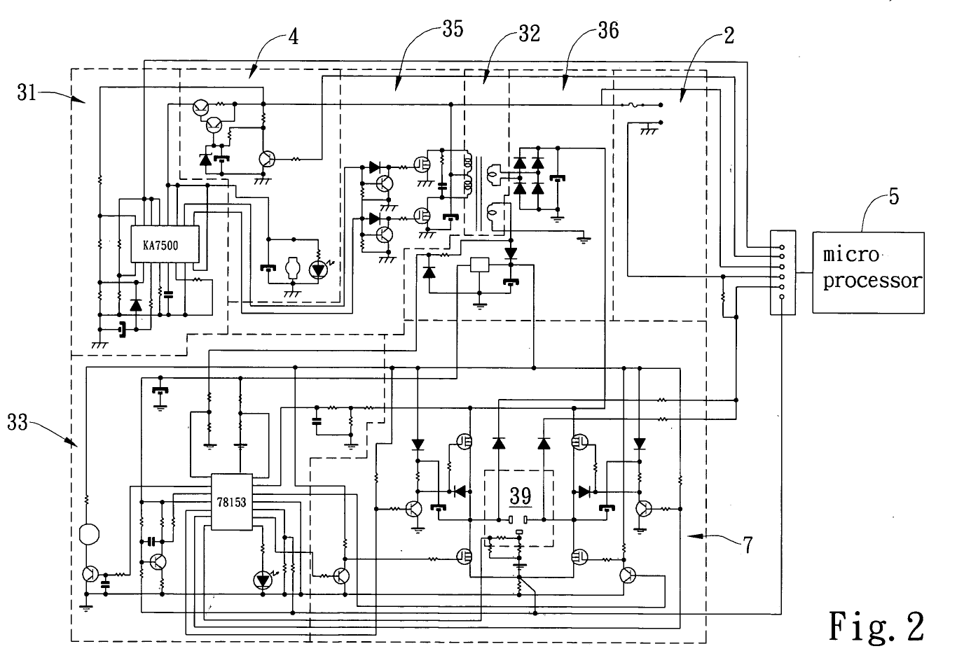

Referring to FIGS. 1 and 2, there is shown a first preferred embodiment of a power inverter 1 in accordance with the present invention. The power inverter 1 includes an electronic switching circuit 4 designed to be electrically connected to a DC power supply 2.

A power inverter circuit 3 is electrically connected to the electronic switching circuit 4 for converting a DC supply voltage to an AC voltage. The power inverter circuit 3 has output terminals 39 to output the resulting AC voltage.

In the illustrated embodiment, the power inverter circuit 3 includes a pulse signal generator 31, a pulse driver 35, a transformer 32 and a rectifier circuit 36 electrically connected in series. The pulse signal generator 31, preferably in the form of a pulsewidth-modulated (PWM) signal generator, is electrically connected to the electronic switching circuit 4. The rectifier circuit 36 supplies a DC rectified voltage both to an AC signal generator 33 and to a DC-AC inverter circuit 34 electrically connected to the AC signal generator 33.

Once the DC power supply 2 is connected, the electronic switching circuit 4 functions as a switch which controls the supply of power from the power supply 2 to the power inverter circuit 3. If the switching circuit 4 is being turned on, the pulse signal generator 31 is supplied with power and outputs a first pulse voltage, which is amplified by the pulse driver 35 and is turned into an amplified second pulse voltage.

The second pulse voltage is applied across a primary winding of the transformer 32 and a secondary winding of the same transformer 32 produces a boosted or reduced third pulse voltage. Then the rectifier circuit 36 changes the third pulse voltage into a DC rectified voltage higher or lower than the supply voltage provided by the DC power supply 2. The DC rectified voltage, as mentioned above, is supplied both to the AC signal generator 33 and to the DC-AC inverter circuit 34.

Now the AC signal generator 33 is energized. It sends an AC signal to the DC-AC inverter circuit 34, which then converts the DC rectified voltage into the AC voltage. It is important that the AC voltage alternates at a frequency depending on that of the AC signal sent from the AC signal generator 33.

Referring still to FIGS. 1 and 2, the inventive power inverter 1 further includes a microprocessor 5 having an oscillating circuit (not shown) provided therein for counting time. The microprocessor 5 is constructed to be able to send a control signal to the electronic switching circuit 4 at a desired time to order the electronic switching circuit 3 to break and close the power inverter circuit 3.

It is preferably that a time-setting means 6 is electrically connected to the microprocessor 5 for setting the desired time by the user. More preferable, a display 7 is provided for displaying the condition of the control signal sent from the microprocessor 5 to the electronic switching circuit 3.

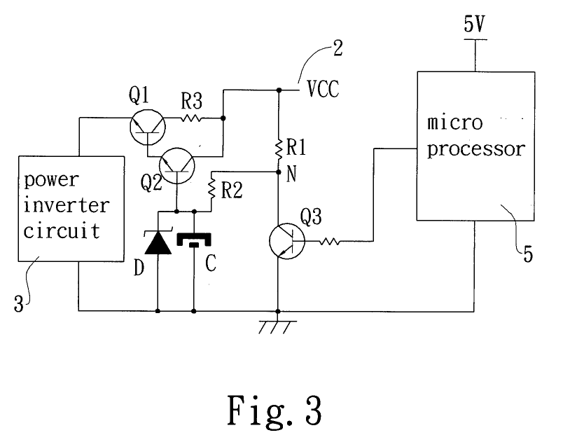

Referring to FIG. 3, the electronic switching circuit 4 includes a first n-p-n bipolar transistor Q1 having an emitter electrically connected to the power inverter circuit 3, and a second n-p-n bipolar transistor Q2 having an emitter electrically connected to a base of the first bipolar transistor Q1 and a collector electrically connected to the supply voltage Vcc provided by the DC power supply 2.

Furthermore, a first resistor R1 is electrically connected between the supply voltage Vcc and a node N, a second resistor R2 is electrically connected between a base of the second bipolar transistor Q2 and the node N, and a third resistor R3 is electrically connected between a collector of the first bipolar transistor Q1 and the supply voltage Vcc.

The electronic switching circuit 4 further includes a third n-p-n bipolar transistor Q3 having an emitter electrically connected to ground, a base electrically connected to the microprocessor 5, and a collector electrically connected to the node N.

Optionally, there may be provided a Zener diode D that has an anode electrically connected to ground and a cathode electrically connected to the base of the second bipolar transistor Q2. A capacitor C may be electrically connected in parallel with the Zener diode D.

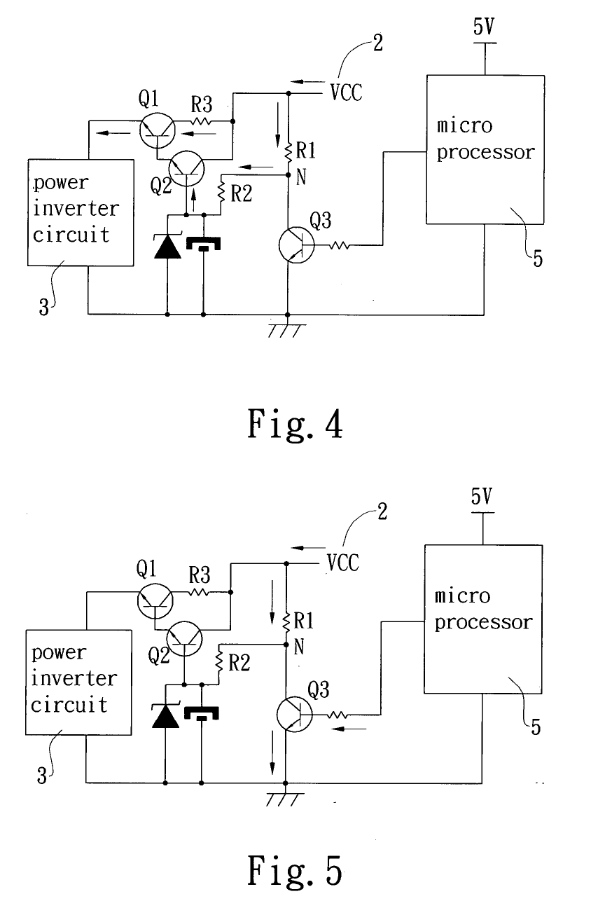

Referring to FIGS. 4 and 5, there are shown diagrams illustrating the flow of electric current in the electronic switching circuit 4. As soon as the user sets the desired time by way of the time-setting device 6, the microprocessor 5 begins to count time resulted from the oscillating circuit. It is at the desired time that the microprocessor 5 sends out such a control signal to the electronic switching circuit 4 that the switching circuit 4 may break or close the power inverter circuit 3.

Alternatively, the microprocessor 5 may control operation of an alarm which may sound or give out light to warm the user or which may emit a radio signal to inform the user.

If the microprocessor 5 sends out a control signal at low level, as shown in FIG. 4, the third bipolar transistor Q3 turns off and an electric current runs from the supply voltage Vcc to the base of the second bipolar transistor Q2. This base current makes the second bipolar transistor Q2 to turn on, i.e. to be conductive between its collector and emitter, and hence the first bipolar transistor Q1 to be conductive between its collector and emitter. Therefore, the power inverter circuit 3 is closed, being supplied with electric power.

If the microprocessor 5 sends out a control signal at high level, as shown in FIG. 5, the third bipolar transistor Q3 turns on and the node N is at a low potential. Now few or no electric current runs to the base of the second bipolar transistor Q2. This makes the second bipolar transistor Q2 and hence the first bipolar transistor Q1 to turn off, so that the power inverter circuit 3 is broken.

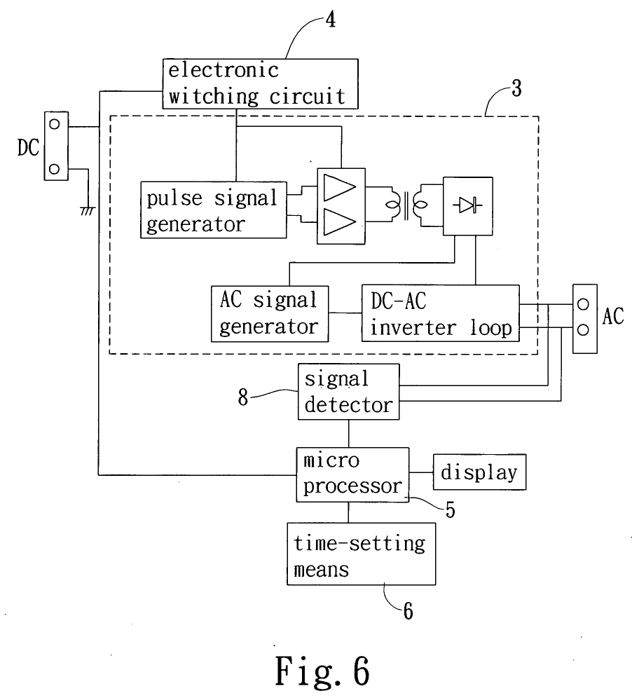

Referring to FIG. 6, a second preferred embodiment of the inventive power inverter 1 is provided with an additional signal detector 8 electrically connected between the microprocessor 5 and the output terminals 39 of the power inverter circuit 3. The signal detector 8 is provided for detecting the current outputted from the power inverter circuit 3.

If a desired period of time have been set via the time-setting means 6, the microprocessor 5 begins to count time whenever it is detected that the power inverter 1 is non-load, i.e. the output current has a magnitude approximately of 0 Ampere while the electronic switching circuit 4 is being turned on.

It is at the end of the desired period of time that the microprocessor 5 will send out a control signal which orders the electronic switching circuit 4 to turn off so as to break the power inverter circuit 3.

From the foregoing, it is apparent that the present invention is advantageous in that:
1. the inventive power inverter can automatically turn on and off itself at a desired time, thereby avoiding the battery from running down unexpectedly; and
2. the inventive power inverter can automatically turn off itself in a desired period of time if being non-loaded, thereby avoiding unnecessary consuming of electric power.

Although embodiments together with structures and functions of the present invention have been described in detail, many modifications and variations may be made from the teachings disclosed hereinabove. Therefore, it should be understood by those skilled in the art that any modification and variation equivalent to the spirit of the present invention be regarded to fall into the scope coved by the appended claims.

What is claimed is:

1. A power inverter comprising:
an electronic switching circuit designed to be electrically connected to a DC power supply;
a power inverter circuit electrically connected to said electronic switching circuit for converting a DC supply voltage to an AC voltage, said power inverter circuit having output terminals to output said AC voltage; and
a microprocessor having an oscillating circuit provided therein for counting time;
wherein said microprocessor is constructed to be able to send a control signal to said electronic switching circuit at a desired time to order said electronic switching circuit to break said power inverter circuit.

2. The power inverter as claimed in claim 1, wherein said electronic switching circuit comprises:
a first n-p-n bipolar transistor having an emitter electrically connected to said power inverter circuit;
a second n-p-n bipolar transistor having an emitter electrically connected to a base of said first n-p-n bipolar transistor, and a collector electrically connected to said supply voltage provided by said DC power supply;
a first resistor electrically connected between said supply voltage and a node;
a second resistor electrically connected between a base of said second n-p-n bipolar transistor and said node;
a third resistor electrically connected between a collector of said first n-p-n bipolar transistor and said supply voltage; and
a third n-p-n bipolar transistor having an emitter electrically connected to ground, a base electrically connected to said microprocessor and a collector electrically connected to said node.

3. The power inverter as claimed in claim 1, wherein said power inverter circuit comprises a pulse signal generator electrically connected to said electronic switching circuit for outputting a first pulse voltage, a pulse driver for amplifying said first pulse voltage to provide an amplified second pulse voltage, a transformer for transforming said second pulse voltage to a third pulse voltage, a rectifier circuit for changing said third pulse voltage into a DC rectified voltage, an AC signal generator supplied with said DC rectified voltage for generating an AC signal, and a DC-AC inverter circuit supplied with said DC rectified voltage for converting said DC rectified voltage to said AC voltage.

4. The power inverter as claimed in claim 3, wherein said pulse signal generator is a pulsewidth-modulated signal generator.

5. The power inverter as claimed in claim 1 further including a time-setting means electrically connected with said microprocessor for setting said desired time by a user.

6. The power inverter as claimed in claim 1 further including a display for displaying the condition of said control signal sent from said microprocessor to said electronic switching circuit.

7. The power inverter as claimed in claim 1 further including a signal detector electrically connected between said microprocessor and said output terminals of said power inverter circuit for detecting an electric current outputted from said power inverter circuit.
